(19) United States
(12) Patent Application Publication
(10) Pub. No.: US 2006/0082412 A1
(43) Pub. Date: Apr. 20, 2006

(54) Single, multiplexed operational amplifier to improve current matching between channels

(76) Inventors: Kevin P. D'Angelo, Santa Clara, CA (US); Bruno Ferrario, Cupertino, CA (US); Dan Dempsey, Menlo Park, CA (US)

Correspondence Address: ADVANCED ANALOGIC TECHNOLOGIES, 830 EAST ARQUES AVE, SUNNYVALE, CA, 94085, US

(21) Appl. No.: 10/970,061

(22) Filed: Oct. 20, 2004

(51) Int. Cl. G05F 1/10

(52) U.S. Cl. 327/541

(57) ABSTRACT

A multi-channel current regulator includes two or more channels, each channel acting as a current source or sink for a respective load. Each channel regulates its load current so that the load current is proportional to an input voltage supplied to the channel. Each channel also generates a feedback voltage that is proportional to the load current of the channel. The current regulator also includes an operational amplifier. The amplifier is connected, using two multiplexors to drive one channel at a time. Each channel is selected in a rotating sequence for connection to the amplifier. Internal gate capacitance maintains each channel not connected to the amplifier at its previously set load current.

### BACKGROUND OF THE INVENTION

Current sources and current sinks are commonly used to provide regulated currents in circuits of all types. As shown in FIG. 1A, a current sink can be constructed as a combination of a sense resistor, a MOSFET and an operational amplifier. The operational amplifier adjusts the voltage at the gate of the MOSFET to minimize the voltage difference between the inputs of the op amp. In a perfect system, the voltage at the source of the MOSFET, Vₛ, equals the voltage on the positive terminal of the amplifier, Vₛₑₜ, and the current is given by I=Vₛₑₜ/R. Figure 1B shows a current source constructed using a similar combination of components.

Duplication of the current sink or source structure can produce additional channels with nearly matched currents when referred to the same set voltage, Vₛₑₜ. For the currents in each channel to be equal, all duplicated elements must exactly match in value and characteristics. Unfortunately, mismatches inevitably result because manufacturing variations are unavoidable. Though mismatch between sense-resistors can be minimized with careful layout, random offset within each amplifier is more difficult to correct and can contribute directly to mismatch between channel currents. In fact, random offset is often the main contributor to mismatch—particularly where R is small since I=Vₛₑₜ/R+Vₒₛ/R. Consider for example, a hypothetical low power implementation where R is 2 Ohms. If Vₒₛ is in the range of −10 mV to 10 mV, then Vₒₛ/R can be as large as 5mA. This would be significant for the case where Vₛₑₜ/R is 20 mA (which would not be unusual for low power devices).

### SUMMARY OF THE INVENTION

The present invention includes a topology for multi-channel current sink and current sources. For a representative embodiment, a series of current sinks are controlled using a single operational amplifier. Each current sink includes a MOSFET connected through a sense resistor to ground. A feedback sense node is defined for each current sink as the voltage over the sense resistor. The voltage at the feedback sense node is proportional to the current flowing through the MOSFET. That current is used to drive a load, such as an LED.

Two multiplexors are used to select one current sink at a time. When selected, one multiplexor connects the feedback sense node of the selected current sink to one of the inputs of the operational amplifier. The second multiplexor connects the output of the operational amplifier to the MOSFET gate of the selected current sink. The operational amplifier compares the feedback sense node voltage to a set voltage Vₛₑₜ and causes the selected current sink to draw a regulated current proportional to Vₛₑₜ. Each current source is selected in sequence. When non-selected, gate capacitance causes the disconnected MOSFETS to maintain their regulated currents. By sequencing through the different current sinks at a predetermined rate, regulation of each current sink is maintained. Additional capacitance can be added at the gate of each MOSFET to decrease the refresh frequency of the current sinks.

The use of a single amplifier multiplexed between current sinks eliminates the contribution of amplifier offset to current mismatch. This topology also reduces power consumption by minimizing the number of active devices.

The topology just described provides an effective driver for multiple white LEDs. To drive RGB LEDs, the individual sense resistors are replaced with a common sense resistor. A PWM signal is then used to drive the separate red, blue and green elements of the RGB LED. The single sense resistor works because only one LED color element is active at any time. The duty cycle of each color element is varied to control the color and intensity of the LED output.

It should also be noted that a similar topology may be used to drive multiple current sources with a single multiplexed amplifier.

### BRIEF DESCRIPTION OF THE DRAWINGS

FIG. 1A is a block diagram of a prior art current sink.

FIG. 1B is a block diagram of a prior art current source.

FIG. 2 is a block diagram of a multi-channel current sink as provided by an embodiment of the present invention.

FIG. 3 is a block diagram of a multi-channel white LED driver as provided by an embodiment of the present invention.

FIG. 4 is a block diagram of an RGB LED driver as provided by an embodiment of the present invention.

FIG. 5 is a block diagram of a multi-channel current source as provided by an embodiment of the present invention.

### DETAILED DESCRIPTION OF THE PREFERRED EMBODIMENTS

The present invention includes a multi-channel current sink. As shown in FIG. 2, a representative implementation of the multi-channel current sink includes a series of four channels, labeled 202a through 202d. The number of channels 202 is entirely implementation dependent and can be more or less than the four shown. Each channel 202 includes a sense resistor (labeled 204a through 204d) and a MOSFET (labeled 206a through 206d). As shown in FIG. 2, a first multiplexor 208 is used to connect the output of an operational amplifier 210 to the gate of one MOSFET 206. At the same time, a second multiplexor 212 connects a feedback sense node (the voltage over the corresponding resistor 204) of the same channel 202 to the negative input of the amplifier 210.

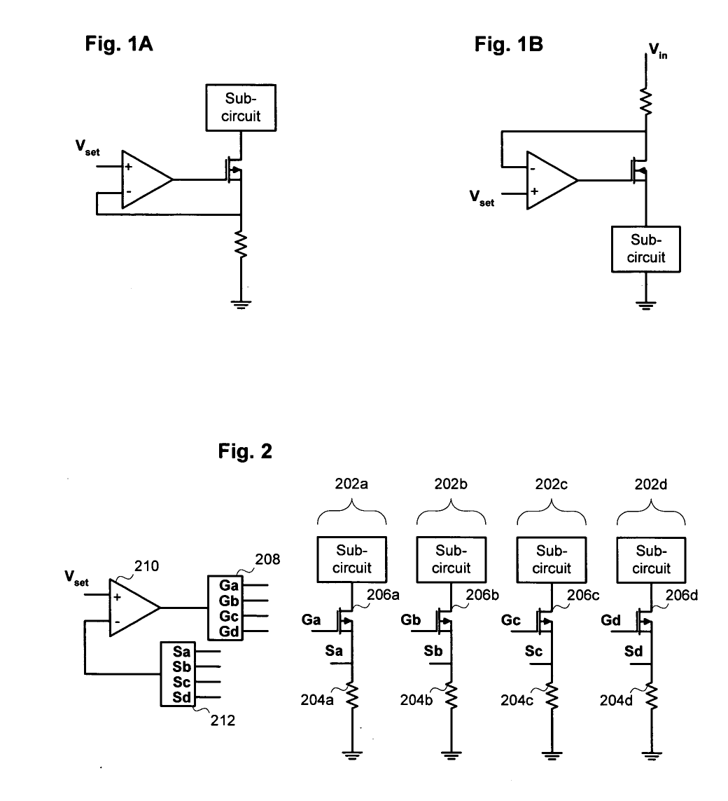

Multiplexor 208 and multiplexor 212 are controlled so that each channel is selected in sequence. When selected, a particular channel 202 is connected to the amplifier 210 and behaves exactly as the circuit in FIG. 1A. This is referred to as the “refresh period” for the selected channel 202. The refresh period for a channel 202 ends when the next channel 202 is selected. Between refresh periods, the gate (MOSFET 206) of the previously selected channel 202 will maintain the voltage set by the amplifier 210 for a finite time. This time is limited by the leakage from the gate capacitance. By cycling both multiplexors through all of the channels in even time intervals, amplifier 210 is able to maintain the voltage at the sense node of each channel 202 thereby maintaining the desired current through each channel 202. The rate of switching between channels 202 is limited on the high end by the speed of the amplifier 210, and the low end by the ability of the gate capacitance to maintain its charge. Additional capacitance can be added between the gate and ground to help maintain the gate voltage between refresh periods.

The use of a single amplifier 210 multiplexed between each channel 202 eliminates the contribution of amplifier offset to current mismatch. This topology also reduces power consumption by minimizing the number of active devices.

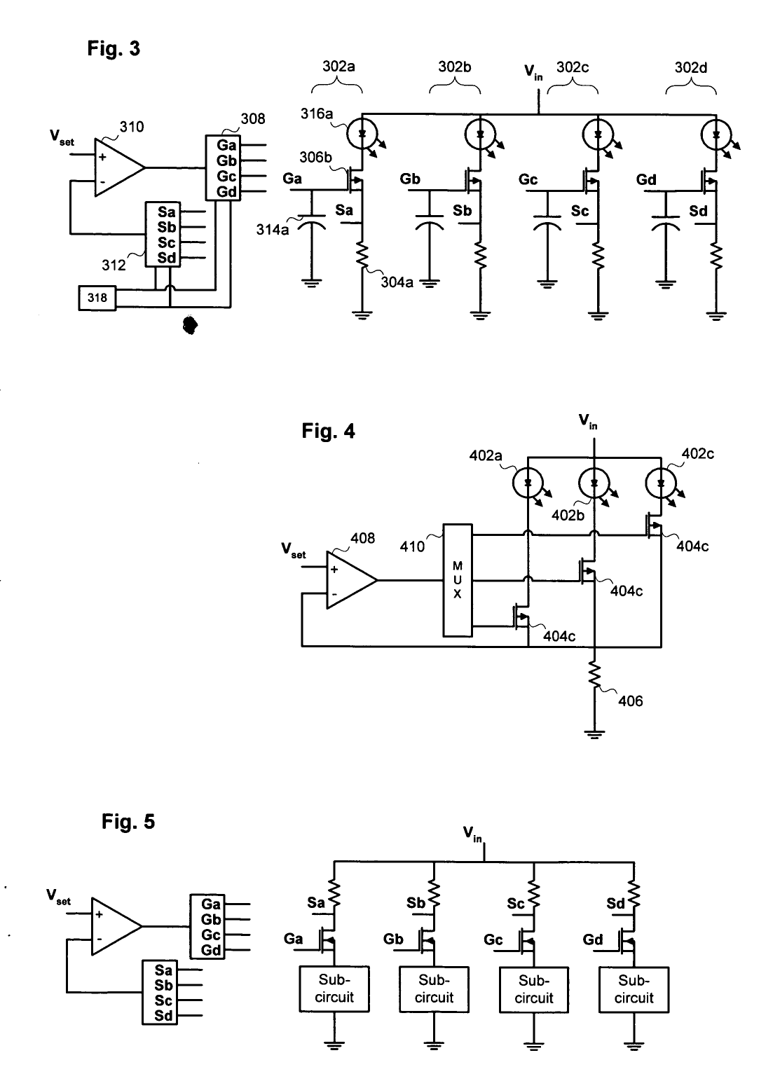

Building on the topology just described, FIG. 3 shows a four-channel multiplexed NMOS sink structure to regulate the current through white light-emitting diodes (LED's). As shown in FIG. 3, each channel 302 includes the sense resistor 304 and MOSFET 306 originally shown in FIG. 2. First multiplexor 308, operational amplifier 310 and second multiplexor 312 are also replicated without change. A capacitor 314 has been added to each channel 302 to add additional capacitance to help maintain the gate voltage between refresh periods. The additional capacitance also helps to filter out spikes in the gate voltage when the operational amplifier 310 is initially connected to the MOSFET 306 at the beginning of each refresh period.

A variable shift register 318 is used to control the channel selection of the multiplexors 308 and 312. The shift register 318 is preferably configured to skip over any channel that has been disabled and refresh only those channels that are intended to conduct current. Typically, this is accomplished using a second register that includes one enable/disable bit per channel. To prevent current flow, it is preferable to ground the gates of all disabled channels.

FIG. 4 shows another implementation where a multiplexed amplifier is used for a pulse-width modulated (PWM) current regulation system for RGB (red-green-blue) LED's. For this implementation a red LED (402a), a green LED (402b) and a blue LED (402c) are connected in series with respective MOSFETS 404a through 404c. The MOSFETS 404 are connected to a common sense resistor 406. An operational amplifier 408 compares the voltage over the sense resistor 406 to an input voltage Vₛₑₜ. A multiplexor 410 connects the output of the operational amplifier 408 to the gate of a selected MOSFET 404.

The red, blue and green LEDS 402 are driven using a pulse width modulation (PWM) scheme. For this scheme, each LED 402 is selected in sequence. The amplifier 408 is then connected to drive the MOSFET 404 associated with the selected LED 402. The amplifier 408 regulates the current through the LED 402 as illustrated for the sink structure of FIG. 1A. Additional logic is used to determine the sequence and duration that each of the LED's 402 should be on. To save power, the gates of all three channels are grounded and the amplifier 408 is disabled during periods when all the LED's 402 should be off.

The implementations described above are based, in part on the current sink topology of FIG. 1A. It should be noted, however that the same techniques may be used with current sources. As an example, FIG. 5 shows four current source channels driven by a single multiplexed amplifier.

What is claimed is:

1. A multi-channel current regulator that comprises:
two or more channels, each channel configured to regulate a load current so that the load current is proportional to an input voltage supplied to the channel, each channel generating a feedback voltage that is proportional to the load current of the channel;
an operational amplifier;
a first multiplexor for connecting the output of the operational amplifier to supply the input voltage of a selected channel; and
a second multiplexor for connecting the feedback voltage of the selected channel to an input of the operational amplifier.

2. A multi-channel current regulator as recited in claim 1 in which each channel acts as a current sink for its load current.

3. A multi-channel current regulator as recited in claim 1 in which each channel acts as a current source for its load current.

4. A multi-channel current regulator as recited in claim 1 that further comprises a control circuit configured to cause each channel to be selected in a repeating sequence.

5. A multi-channel current regulator that comprises:
two or more channels, each channel configured to regulate a load current so that the load current is proportional to an input voltage supplied to the channel,
a control circuit configured to select each channel in a repeating sequence;
an operational amplifier;
a feedback circuit configured to supply an input of the operational amplifier with a feedback voltage that is proportional to the load current of the selected channel; and
a multiplexor for connecting the output of the operational amplifier to supply the input voltage of the selected channel.

6. A multi-channel current regulator as recited in claim 5 in which each channel acts as a current sink for its load current.

7. A multi-channel current regulator as recited in claim 5 in which each channel acts as a current source for its load current.

8. A multi-channel current regulator as recited in claim 5 that further comprises a shift register configured to cause each channel to be selected in the repeating sequence.

9. A multi-channel current regulator as recited in claim 5 in which each channel is connected to act as a current source or current sink for an element of a RGB LED.

10. A multi-channel current regulator as recited in claim 9 that further comprises a PWM circuit for varying the duty cycle of each selected channel.

11. A method for controlling a series of two or more channels where each channel is configured to regulate a load current so that the load current is proportional to an input voltage supplied to the channel, each channel generating a feedback voltage that is proportional to the load current of the channel, the method comprising:
selecting a channel from the series;
connecting the output of an operational amplifier to supply the input voltage of a selected channel; and
connecting the feedback voltage of the selected channel to an input of the operational amplifier.

12. A method as recited in claim 11 in which each channel acts as a current sink for its load current.

13. A method as recited in claim 11 in which each channel acts as a current source for its load current.

14. A method as recited in claim 11 in which each channel is selected in a repeating sequence.

15. A method for controlling a series of two or more channels where each channel is configured to regulate a load current so that the load current is proportional to an input voltage supplied to the channel, the method comprising:
selecting each channel in a repeating sequence;
connecting a feedback circuit to the selected channel to supply an input of an operational amplifier with a feedback voltage that is proportional to the load current of the selected channel; and
connecting the output of the operational amplifier to supply the input voltage of the selected channel.

16. A method as recited in claim 15 in which each channel acts as a current sink for its load current.

17. A method as recited in claim 15 in which each channel acts as a current source for its load current.

19. A method as recited in claim 15 in which each channel is connected to act as a current source or current sink for an element of a RGB LED.

20. A method as recited in claim 15 that further comprises varying the duty cycle of each selected channel.
